(19) United States
(12) Patent Application Publication
(10) Pub. No.: US 2012/0271556 A1
(43) Pub. Date: Oct. 25, 2012

(54) METHOD AND DEVICE FOR ESTIMATING BIOLOGICAL OR CHEMICAL PARAMETERS IN A SAMPLE, CORRESPONDING METHOD FOR AIDING DIAGNOSIS

(75) Inventors: Pascal SZACHERSKI, Seyssinet-Pariset (FR); Jean-François GIOVANNELLI, Bordeaux (FR); Pierre GRANGEAT, Saint Ismier (FR)

(73) Assignee: Commissariat a l'energie atomique et aux ene alt, Paris (FR)

(21) Appl. No.: 13/438,977

(22) Filed: Apr. 4, 2012

(30) Foreign Application Priority Data
Apr. 6, 2011 (FR) 11 53008

(51) Int. Cl. G06F 19/00

(52) U.S. Cl. 702/19; 702/22; 702/23

(57) ABSTRACT

This method for estimating biological or chemical parameters in a sample (E) comprises steps consisting of putting (102) the sample (E) through a processing chain, obtaining a signal representative of said biological or chemical parameters as a function of at least one variable of the processing chain, and estimating (104, 106, 108, 110) said biological or chemical parameters using a signal processing device by Bayesian inference, on the basis of a direct analytical modeling of said signal as a function of said biological or chemical parameters of the biological sample and as a function of technical parameters of the processing chain.

At least two of said biological or chemical and technical parameters have a probabilistic dependence relationship between each other and signal processing by Bayesian inference is further accomplished on the basis of modeling by a conditional prior probability distribution of this dependence.

This invention relates to a method and system for estimating biological or chemical parameters in a sample. It also concerns a corresponding method for aiding diagnosis.

An especially promising application of this type of method is the analysis of biological samples such as blood or plasma samples to establish biological parameters such as estimates of molecular concentrations in proteins. Understanding these concentrations will help detect abnormalities or diseases. It is known that some diseases such as cancers can, even in the early stages, have an impact that may appear in molecular concentrations of certain proteins. More generally, the analysis of samples for determining relevant parameters to help diagnose a state (health, pollution, . . . ) that may be associated with these samples, is a promising area of application of a method according to the invention.

The following specific applications may be noted: biological analysis of samples by detecting proteins; characterization of bacteria by mass spectrometry; characterization of the pollution status of a chemical sample (such as gas concentrations in an environment or proportions of heavy metals in a liquid sample). Relevant determined parameters may include concentrations of components such as molecules (peptides, proteins, enzymes, antibodies, . . . ) or molecular self-assemblies. The term molecular self-assemblies means for instance a nanoparticle or a biological species (such as a bacteria, a microorganism, a cell, . . . ).

In biological analysis through protein detection, the difficulty resides in arriving at the most accurate estimate possible in a noisy environment where proteins of interest are sometimes present in the sample only in very small numbers.

In general, the sample passes through a processing chain that includes a chromatography column or a mass spectrometer, or both. This processing chain is designed to produce a signal representative of the molecular concentrations of components in the sample, as a function of a retention time in the chromatography column or of a mass-to-charge ratio in the mass spectrometer, or both.

The processing chain may include a centrifuge and/or a column for affinity capture occurring upstream of the chromatography column, so as to purify the sample. Moreover, the chain may also include, upstream of the chromatography column too and when the components for study are proteins, a digestion column which divides proteins into smaller peptides that are better adapted to the measuring range of the mass spectrometer. Lastly, when the processing chain simultaneously features both the chromatography column, which must be traversed by a sample in liquid phase, and the mass spectrometer, which requires that the sample be in the nebulized gas phase, it must further include an electro-spray (or equivalent) that can change to the required phase, in this case by nebulization of the mix coming out of the chromatography column.

Thus, when the processing chain includes the chromatography column and the mass spectrometer, a judicious adaptation of the temporal sampling period of mass spectrometer measurements to a multiple of the temporal sampling period of chromatography column measurements will result in a bi-dimensional signal for which the positive amplitude varies as a function of retention time in the chromatography column in one dimension and of the mass-to-charge ratio determined by the mass spectrometer in the other dimension. This bi-dimensional signal presents a multitude of peaks revealing concentrations of components more or less drowned in noise and more or less superimposed upon each other.

A known method for estimating concentrations of components consists of measuring the heights of peaks or their integral features (surface, volume) above a certain level, then inferring concentration of a corresponding component. Another method known as “spectral analysis” consists of comparing the bi-dimensional signal in its entirety to a library of indexed models. However, these methods are generally subject to a lack of accuracy or reliability, especially when peaks are barely marked or are less visible because of noise or because of very similar peaks that are superimposed.

Another known method consists of analytically formulating the processing chain and thus obtaining a direct model of the output signal which will then be subject to an estimate of biological or chemical parameters by inverting this model using actually observed values for the signal and a Bayesian inference technique. A process such as this is described in the European patent application published under the number EP 2 028 486. It comprises the following steps:
put the sample through a processing chain,
obtain a representative signal of concentrations of the components of the sample depending on at least one variable of the processing chain, and
estimate said concentrations using a signal processing device by Bayesian inference, on the basis of a direct analytical modeling of said signal as a function of biological parameters of the sample, among which may be found a representative vector of concentrations of the said components, and on the basis of technical parameters of the processing chain.

The analytical modeling proposed in this document makes the observed chromato-spectrographic signal dependent on the following biological and technical parameters: a vector representing P protein concentrations, a vector representing I peptide concentrations, said peptides resulting from a digestion of said P proteins, a general gain parameter of the processing chain, a noise parameter and a parameter for retention time in the chromatography column. Values of some of these parameters are variable or unknown from one chromato-spectrography to another. Each of these parameters are then modeled by independent probability distributions (such as for the protein concentration vector, the gain parameter, the noise parameter and the retention time parameter), while others are obtained deterministically, through learning (such as for the molecular peptide concentration vector being determined form a vector of protein concentrations and an invariable digestion matrix), or possibly by calibration of the processing chain.

However, the model chosen in EP 2 028 486 presents constraints that impact on the accuracy and reliability of the final estimate. It could thus prove desirable to set up a method for estimating biological or chemical parameters that removes at least part of the problems and constraints cited earlier and improves existing methods.

Therefore, a method for estimating biological or chemical parameters in a sample is being proposed that comprises the following steps:
put the sample through a processing chain,
obtain a representative signal of said biological or chemical parameters as a function of at least one variable of the processing chain, and
estimate said biological or chemical parameters using a signal processing device by Bayesian inference, on the basis of a direct analytical modeling of said signal as a function of said biological or chemical parameters and on as a function of technical parameters of the processing chain,
   wherein, furthermore:
at least two of said biological or chemical or technical parameters as a function of which direct analytical modeling of said signal is defined have a probabilistic dependence relationship with each other, and
said signal processing by Bayesian inference is furthermore carried out on the basis of modeling by a conditional prior probability distribution of this dependence.

Thus the modeling can be refined and therefore can get close to fact, by integrating a hierarchy of certain parameters using probabilistic dependences reflected by conditional probabilities distributions, with the understanding that these probabilistic dependencies may be modeled by prior probabilities, either through a specific learning experience or by means of a realist model established through experience. Ultimately, the result will be a better estimate of the biological or chemical parameters involved.

Optionally, the estimating step of said biological or chemical parameters may include the following, by approximation of the posterior joint probability distribution of said biological or chemical parameters and technical parameters conditionally to the obtained signal, using a stochastic sampling algorithm:
a sampling loop of at least part of said biological or chemical parameters of the sample and of at least part of said technical parameters of the processing chain, providing sampled values of these parameters, and
an estimate of said at least part of said biological or chemical and technical parameters calculated from said provided sampled values.

Thus, on the basis of an understanding of models of prior probabilities distributions, conditional or not, for at least part of the biological and/or technical parameters, it becomes possible to simply process the signal provided by the biological processing chain to establish estimates of these parameters.

Also optionally, the estimate of said at least part of said biological or chemical and technical parameters calculated from said provided sampled values may include:
a calculation of the expectation or median or maximum a posteriori estimator for each continuous values parameter,
a calculation of the maximum a posteriori estimator for each discrete values parameter, or
a probability calculation of at least part of said biological or chemical and technical parameters.

Also optionally, the biological or chemical parameters include a vector representative of concentrations of sample components, said method further including a preliminary calibration phase, called external calibration, that comprises the following steps:
put a sample of external calibration components through the processing chain, with these external calibration components chosen from among the components of said sample and whose concentrations are known,
by this means obtain a signal representative of concentrations of external calibration components as a function of at least one variable of the processing chain and of at least one constant parameter of unknown value and/or of at least one stable statistic parameter of the processing chain,
apply at least part of said estimating step of said biological or chemical parameters using the signal processing device by Bayesian inference, to infer the value of each constant parameter of unknown value and/or of each stable statistic parameter of the processing chain,
save each constant parameter value and/or each stable statistic parameter value previously inferred in a memory.

Also optionally, said biological or chemical parameters may be relative to proteins and the sample may include one of the elements of the group consisting of blood, plasma and urine.

Also optionally:
the signal representative of said biological or chemical parameters is expressed as a function of molecular species concentrations,
these species come from a decomposition of molecular species of interest,
the method includes an estimate of the number of said species obtained resulting from said decomposition of molecular species of interest.

Also optionally:
the species contain peptides or polypeptides,
the molecular species of interest contain proteins that each have a number of these peptides and polypeptides,
a digestion yield of proteins is defined as a coefficients αᵢₚ matrix, where αᵢₚ designates the digestion yield of the p-th protein with relation to the i-th peptide or polypeptide, such that the molecular concentrations of peptides and polypeptides are linked to a vector representative of protein concentrations via a digestion matrix and said digestion yield,
the method includes an estimate of this digestion yield.

Also optionally:
the species contain peptides or polypeptides,
the molecular species of interest contain proteins that each have a number of these peptides or polypeptides,
an overall gain ξ of the processing chain is defined so as to model said signal Y representative of biological or chemical parameters by the relationship Y=ξ K, where K is a vector representative of concentrations of peptides or polypeptides,
the method includes an estimate of this overall gain.

A method for aiding diagnosis is also proposed that comprises the steps of a method for estimating biological or chemical parameters as described earlier, wherein the biological or chemical parameters of the sample contain a biological or chemical state parameter with discrete values, each possible discrete value of that parameter being associated with a possible state of the sample, and a vector representative of concentrations of components of the sample, and wherein since the vector representative of concentrations and the biological or chemical state parameter have a probabilistic dependence between each other, the signal processing by Bayesian inference is furthermore carried out on the basis of modeling by prior probability distribution of the vector representative of concentrations conditionally to possible values of the biological or chemical state parameter.

Optionally, a method for aiding diagnosis according to the invention may include a preliminary learning phase containing the following steps:
successively put a plurality of reference samples through the processing chain, with the value of the biological or chemical state parameter known for each reference sample,
obtain a representative signal of concentrations of the components for each reference sample depending on at least one variable of the processing chain,
apply at least part of the biological or chemical parameters estimating step using the signal processing device by Bayesian inference to infer values of component concentrations for each reference sample,
determine parameters of prior probability distribution for the vector representative of concentrations conditionally to possible values of the biological or chemical state parameters, and
save these probability distribution parameters in a memory.

Also optionally, a method for aiding diagnosis according to the invention may include a preliminary phase for selecting said components from a pool of candidate components, said preliminary selection phase comprising the following steps:
successively put a plurality of reference samples through the processing chain, with the value of the biological or chemical state parameter known for each reference sample,
obtain a signal representative of concentrations of the candidate components for each reference sample as a function of at least one variable of the processing chain,
apply at least part of the biological or chemical parameters estimating step using the signal processing device by Bayesian inference to infer values representative of concentrations of candidate components for each reference sample,
determine parameters of distribution of the vector representative of concentrations of candidate components for each discrete value of the biological or chemical state parameter,
select from among the candidate components those for which the distributions are the most dissimilar from each other as a function of the biological or chemical state parameter values.

Lastly, an estimating device for biological or chemical parameters in a sample is also proposed, comprising:
a processing chain of the sample designed for providing a signal representative of said biological or chemical parameters as a function of at least one variable of the processing chain,
A signal processing device designed for applying, in combination with the processing chain, a method for estimating biological or chemical parameters or for aiding diagnosis such as outlined earlier.

Optionally, the processing chain may include a chromatography column and/or a mass spectrometer and is designed to provide a signal representative of concentrations of components of the sample as a function of a retention time in the chromatography column and/or a mass-to-charge ratio in the mass spectrometer.

The invention will be better understood through the description provided below, which is given solely as an example and is done through reference to the appended drawings, in which:

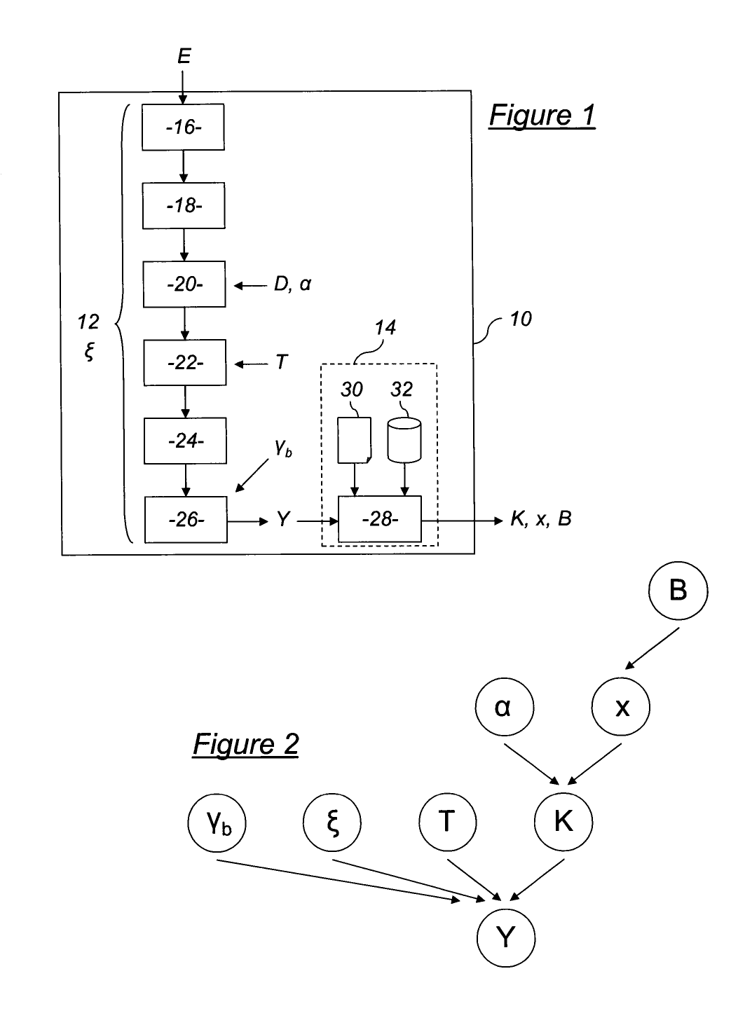

FIG. 1 provides a schematic representation of the overall structure of a device for estimating biological or chemical parameters and for aiding diagnosis according to an embodiment of the invention,

FIG. 2 shows an hierarchical analytical modeling of a processing chain of the device shown in FIG. 1, according to an embodiment of the invention, and

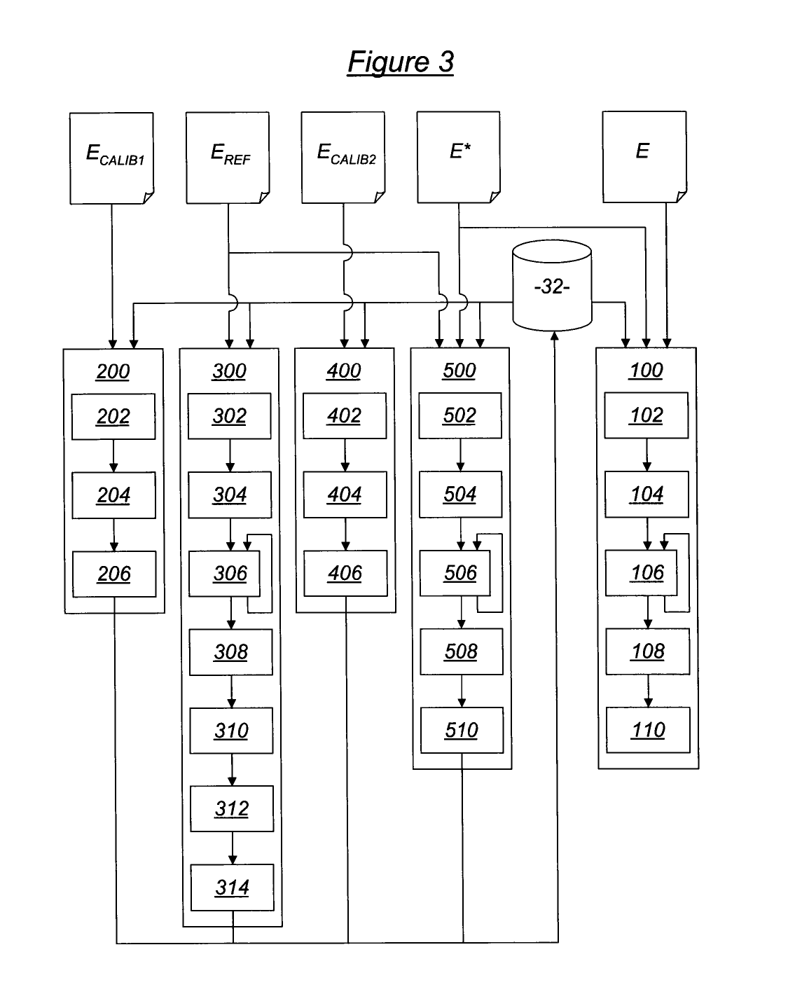

FIG. 3 illustrates the successive steps of a method for estimating biological or chemical parameters and for aiding diagnosis according to an embodiment of the invention.

The device 10 for estimating biological or chemical parameters in a sample E, represented schematically in FIG. 1, includes a processing chain 12 for processing sample E, said chain being designed to provide a signal Y representative of these biological or chemical parameters as a function of at least one variable of the processing chain 12. It furthermore comprises a signal processing device 14 designed for applying, in combination with the processing chain 12, a method for estimating said biological or chemical parameters and for aiding diagnosis as a function of these parameters.

In the example detailed below, which should not be considered limiting, the estimated parameters are biological parameters, among which concentrations of biological components of sample E which is then considered as a biological sample, and the processing chain 12 is a biological processing chain. More precisely, the components are proteins of interest, for instance selected as a function of their relevance to characterize an abnormality, ailment or disease, and sample E is a sample of blood, plasma or urine. We will then refer to molecular concentrations of proteins to designate the concentrations of these particular components.

In the biological processing chain 12, sample E is first put through a centrifuge 16 and then in a capture by affinity column 18, for purification.

It then passes through a digestion column 20 that sections its proteins into smaller peptides using an enzyme such as trypsine. The digestion process may be modeled by a digestion matrix D, outlining deterministically how each protein of interest is divided up into peptides, and by a digestion coefficient a characterizing the yield of this digestion process. This coefficient a may be qualified as an uncertain parameter in that it is susceptible to change randomly from one biological processing phase to another. It may therefore be advantageously modeled according to a pre-determined prior probability distribution, such as a uniform distribution covering an interval in [0,1].

Sample E then passes successively through a liquid chromatography column 22, an electro-spray 24 and a mass spectrometer 26, to provide a signal Y which is then representative of molecular protein concentrations in sample E as a function of a retention time in the chromatography column 22 and of a mass-to-charge ratio in the mass spectrometer 26. This signal Y may then be qualified as a chromatospectrogram. As indicated earlier, with a judicious adaptation of the temporal sampling period of mass spectrometer 26 measurements to a multiple of the temporal sampling period of chromatography column 22, the signal Y will appear as a bi-dimensional signal for which the positive amplitude varies as a function of retention time in the chromatography column 22 in one dimension and of the mass-to-charge ratio determined by the mass spectrometer in the other dimension.

Separating peptides in the chromatography column 22 is done as a function of their retention time T in this column. This parameter T is also an uncertain parameter since it is susceptible to change randomly from one biological processing phase to another. It may therefore by advantageously modeled according to a pre-determined prior probability distribution.

The observable signal Y exiting from the mass spectrometer 26 may be considered as having been perturbed by a noise, the inverse variance of which is determined by a parameter γ_{b}. This noise parameter is also an uncertain parameter since it is susceptible to change randomly from one biological processing phase to another. It may therefore by advantageously modeled according to a pre-determined prior probability distribution.

Lastly, overall the processing chain 12 presents a gain ξ which also is an uncertain parameter susceptible to change randomly from one biological processing phase to another. It may therefore by advantageously modeled according to a pre-determined prior probability distribution.

The bi-dimensional signal Y is provided at the entry of the processing device 14. More precisely, the processing device 14 comprises a processor 28 linked to a storage unit that includes at least one programmed sequence of instructions 30 and a modeling database 32.

The database 32 contains the parameters of a direct analytical modeling of the signal Y as a function of:
biological parameters of sample E, among which may be found a vector x representative of molecular concentrations of proteins of interest and a biological state parameter B with discrete values, each possible discrete value of this parameter associated with a possible pre-determined state of sample E,
the previously cited technical parameters D, α, T, ξ and γ_{b} of the biological processing chain 12, and
another technical parameter K, which is a vector representative of molecular concentrations of peptides obtained through digestion of proteins of interest and directly linked to vector x via parameters D and α.

It should be noted that the gain parameter ξ is not known absolutely and without this absolute knowledge it is not possible to make a proper estimate of concentration x of the proteins of interest. Practically, this problem is overcome by inserting marker proteins equivalent to proteins of interest (but with different masses) into sample E prior to going through the processing chain 12. Concentration x* of these marker proteins is known, so that the gain as well as the concentration x may then be estimated using x* and a comparison of peaks corresponding to proteins of interest and marker proteins in the observed signal Y.

The direct analytical modeling of signal Y is thus expressed as follows:

$$Y = {\sum }_{i = 1}^{I} {\sum }_{j = 1}^{J} {\sum }_{K = 1}^{K} {ξ}_{i} {π}_{ij} ( {K}_{i} {π}_{ijk}^{′} {s}_{ijk} + {K}_{i}^{*} {π}_{ijk}^{′ *} {s}_{ijk}^{*} ) {c}_{i}^{T} ( {T}_{i} ) + b ( {γ}_{b} ) , \\ with {K}_{i} = {\sum }_{p = 1}^{P} {x}_{p} {α}_{ip} {d}_{ip} , \qquad ( 1 )$$

where I is the number of peptides, J the number of charges and K the number of supplementary neutrons that a peptide may have, P the number of proteins of interest, xₚ the molecular concentration in p-th protein of interest, αᵢₚ the digestion yield of the p-th protein with relation to the i-th peptide, dᵢₚ the number of i-ths peptides provided through digestion of the p-th protein, ξᵢ the gain of the biological processing chain relative to the i-th peptide, πᵢⱼ the percentage of i-th peptide with j charges, π′ᵢⱼₖ the percentage of i-th peptides with j charges with extra k neutrons, sᵢⱼₖ the theoretic spectrum discretized of peptide i carrying j charges and extra k neutrons, Kᵢ the molecular concentration in i-th peptide, cᵢ^{T}(Tᵢ) the molecular flow of the i-th peptide in the chromatography column, b(γ_{b}) the noise model and where the “*” designates, where required, the same parameters associated to marker proteins. The value for αᵢₚ is between 0 and 1. Vector K, comprising the concentrations Kᵢ of each peptide i in a volume equal to the initial volume of the protein sample, may contain not only isolated peptides, meaning well-digested peptides, but also polypeptides, for example those resulting from improper digestion, with these then being assimilated to a peptide in the model. In this case, matrix D states the number of peptides and polypeptides produced through digestion of a protein and coefficients αᵢₚ represent a yield that can be variable for different peptides i of a protein p. This involves accounting for properly digested peptides, but also for improperly digested polypeptides. All peptides are nonetheless processed in the same way, with improperly digested polypeptides assimilated to a peptide in the modeling.

When the Y signal effectively observed is furnished, the programmed sequence of instructions 30 is designed to resolve the inversion of this analytical model in a Bayesian framework by means of a posterior estimate based on probability models, such as prior probability models, of at least a part of the aforementioned parameters.

The sequence of instructions 30 and the database 32 are functionally presented as distinct in FIG. 1, but in practice they may be split up differently in data files, source codes or computerized libraries without having any impact at all on their functions.

Some of the previously cited parameters are uncertain and are modeled by continuous and discrete prior probabilities distributions: These include the technical parameters γ_{b}, ξ, T, K, K* et α of the biological processing chain 12 and biological parameters x and B. These parameters, including vector x (used for estimating molecular concentrations of proteins) and the biologic state parameter B (for aiding diagnosis) are estimated by the inversion of the direct model according to a process that will be detailed in reference to FIG. 3.

As illustrated in FIG. 2, some of these uncertain parameters are defined as having a probabilistic dependence relationship with each other, leading to an overall hierarchic probabilistic model.

Thus, in our particular example, vector x representing molecular concentrations of proteins of interest is defined as dependent on biological state B. One can conceive that the random variable x realistically follows a probability distribution that varies as a function of the state associated with sample E.

Likewise, vector K representing molecular concentrations of peptides, is dependent on vector x and on digestion matrix a comprising the terms αᵢₚ, which corresponds well with our realist digestion model with a yield lower than 1.

Likewise, vector K* representing molecular concentrations of peptides coming from marker proteins is dependent on the constant and known vector x* and on digestion matrix α, which corresponds well with our realist digestion model with a yield lower than 1.

Consequently, at a first hierarchal level of the probabilistic model, the observed signal Y depends solely on the random variables γ_{b}, ξ, T, K and K*. At a second hierarchal level of the probabilistic model, vector K depends solely on random variables α and x, and K* on the random variable α and on fixed variable x*. At a third hierarchal level of the probabilistic model, vector x depends on the random discrete value variable B. Note in particular that this hierarchal model gives rise to a hierarchy between the biological and technical parameters, through the dependence defined between K and x (and also between K* and x*) via a: it then presents a first technical stage, dependent on a second biological stage, each of which can itself feature an internal hierarchy depending on which model is used.

We shall now describe a method for estimating molecular concentrations of proteins of interest and for aiding diagnosis on the basis of this probabilistic hierarchal model, which is implemented by the processor 28 by executing the sequence of instructions 30:

Three possibilities exist for the inversion:

1) The ionization gain ξ is known, and a will be estimated;

2) The digestion matrix α is known, either through prior knowledge (database, former experiences), or by means of external calibration as described below (phases 200 and 400), or known through a monitoring model bringing in important physical parameters like pH, digestion solution temperature or the length of time of digestion, in which case ionization gain ξ will be estimated;

3) Neither item is known, in which case following interchangeability of the two coefficients, only an overall gain equivalent to that to be noted for ξ′ will be estimated.

In the following part, we will first describe the theory with all parameters. In dealing with the aforementioned cases, it is appropriate to:
For case 1), suppose that ξ=ξ₀ i.e., the probability distribution for ξ is a Dirac centered on ξ₀;
For case 2), suppose that α=α₀ i.e., the probability distribution for α is a Dirac centered on α₀;
For case 3), suppose that αᵢₚ=1 for all i and for all p, i.e. the probability distribution for α is a Dirac centered on 1, which means that the inversion process will estimate the product of the variables that is an overall equivalent gain ξ′ and is not separable because of the nature of the equations in the direct model.

The first case involves doing an estimate of the concentration of peptides K* from marker proteins. In the third case, vector K is not the concentration of peptides strictly speaking, but a vector K′ with an equivalent potential concentration from a digestion with no loss and without discrimination of improperly digested peptides, K′=Dx and K′*=Dx*.

According to this method, estimating molecular concentrations x is done together with the estimate of all random variables γ_{b}, ξ, T, K, K*, α, x and B by means of an estimator on the posterior joint probability distribution of these random variables in view of observation Y. This posterior joint probability develops as follows according to the Bayesian rule:

$$p ( {γ}_{b} , ξ , T , K , {K}^{*} , α , x , B \vert Y ) = \frac{p ( Y \vert {γ}_{b} , ξ , T , K , {K}^{*} , α , x , B ) \cdot p ( {γ}_{b} , ξ , T , K , {K}^{*} , α , x , B )}{p ( Y )} . \qquad ( 2 )$$

Although the likelihood distribution may be expressed analytically and although the joint distribution of parameters p(γ_{b},ξ,T,K,K*,α,x,B) may be developed in a product of conditional prior probabilities that can be modeled through experience or by specific calibration, marginal distribution p(Y) is unknown and cannot be calculated analytically. Consequently, the posterior joint probability distribution cannot be calculated analytically either since this multiplicative factor p(Y) is unknown, yet remains constant for all parameters. This unknown multiplicative factor is therefore not penalizing.

Still, the calculation of an estimator, such as the expectation a posteriori, median a posteriori or maximum a posteriori estimator, cannot be done analytically in a simple manner on this posterior joint distribution. Yet it would be appropriate to apply the median a posteriori estimator on continuous probabilities distributions parameters (γ_{b}, ξ, T, K, K*, α, x) and the maximum a posteriori estimator on the discrete probability distribution parameter (B).

To get around this impossibility of directly calculating such an estimator on the posterior joint distribution of equation (2), it is equivalent and advantageous to proceed with a stochastic digital sampling of each of parameters γ_{b}, ξ, T, K, K*, α, x and B according to the conditional posterior probability distribution that it verifies, as with the known Markov Chain Monte-Carlo process (the MCMC sampling process), which constitutes an approximation of a random selection under the posterior joint distribution. In particular, the digital MCMC sampling can be carried out using iterative methods such as the Gibbs stochastic sampling, which may involve using the Metropolis-Hastings algorithm, and the estimator, for example the expectation a posterior estimator, may then be approached simply through average values of the respective samplings.

Indeed, it can be shown that while the posterior joint probability distribution of equation (2) cannot be expressed analytically through prior probabilities (conditional or not), in contrast, this is possible with the pre-cited conditional posterior probabilities distributions, as will now be stated in detail.

In particular, taking into account the hierarchy of the probabilistic model in FIG. 2, and also of the Bayesian rule and of the possible marginalization of the joint probability distribution of the involved random variables, it can be easily shown that the conditional posterior probability distribution followed by noise parameter γ_{b} takes the following form: p(γ_{b}|Y,ξ,T,K,K*α,x,B)=p(γ_{b}|Y,ξ,T,K,K*), since γ_{b} may be considered as a posteriori independent from α, x and B, its dependence with relation to these parameters moving through K and K*.

According to the Bayesian rule used on the second member of the previous equation:

$$\begin{matrix}p ( {γ}_{b} \vert Y , ξ , T , K , {K}^{*} , α , x , B ) = \frac{p ( {γ}_{b} , Y , ξ , T , K , {K}^{*} )}{p ( Y , ξ , T , K , {K}^{*} )} \\ = \frac{p ( {γ}_{b} , Y , ξ , T , K , {K}^{*} )}{\int p ( {γ}_{b} , Y , ξ , T , K , {K}^{*} ) d {γ}_{b}} \\ = \frac{p ( {γ}_{b} ) p ( ξ ) p ( T ) p ( K ) p ( {K}^{*} ) p ( Y \vert {γ}_{b} , ξ , T , K , {K}^{*} )}{p ( ξ ) p ( T ) p ( K ) p ( {K}^{*} ) \int p ( {γ}_{b} ) p ( Y \vert {γ}_{b} , ξ , T , K , {K}^{*} ) d {γ}_{b}} \\ = p ( Y \vert {γ}_{b} , ξ , T , K , {K}^{*} ) p ( {γ}_{b} ) \frac{1}{\int p ( {γ}_{b} ) p ( Y \vert {γ}_{b} , ξ , T , K , {K}^{*} ) d {γ}_{b}} \\ ∝ p ( Y \vert {γ}_{b} , ξ , T , K , {K}^{*} ) p ( {γ}_{b} )\end{matrix}$$

where ∝ is the symbol of proportionality, the said proportionality being verified since the expression

$$\frac{1}{\int p ( {γ}_{b} ) p ( Y \vert {γ}_{b} , ξ , T , K , {K}^{*} ) d {γ}_{b}}$$

is a coefficient independent from γ_{b}.

In the same way, we can show that:

p(ξ|Y,γ_{b},T,K,K*,α,x,B)∝p(Y|γ_{b},ξ,T,K,K*)p(ξ), and

p(T|Y,γ_{b},ξ,K,K*,α,x,B)∝p(Y|γ_{b},ξ,T,K,K*)p(T).

Concerning parameter K: p(K|Y,γ_{b},ξ,T,α,K*,x,B)=p(K|Y,γ_{b},ξ,T,α,K*,x), since K may be considered as a posteriori independent from B, since its dependence with relation to this parameter B moves through x.

According to the Bayesian rule used on the second member of the previous equation:

$$p ( K \vert Y , {γ}_{b} , ξ , T , α , {K}^{*} , x , B ) = \frac{p ( {γ}_{b} , Y , ξ , T , K , {K}^{*} , α , x )}{\int p ( {γ}_{b} , Y , ξ , T , K , {K}^{*} , α , x ) d K} = \frac{p ( {γ}_{b} ) p ( ξ ) p ( T ) p ( K , {K}^{*} , α , x ) p ( Y \vert {γ}_{b} , ξ , T , K , {K}^{*} , α , x )}{p ( {γ}_{b} ) p ( ξ ) p ( T ) \int p ( K , {K}^{*} , α , x ) p ( Y \vert {γ}_{b} , ξ , T , K , {K}^{*} ) d K} = p ( Y \vert {γ}_{b} , ξ , T , K , {K}^{*} ) p ( K \vert α , x ) \frac{p ( {K}^{*} , α , x )}{\int p ( K , {K}^{*} , α , x ) p ( Y \vert {γ}_{b} , ξ , T , K , {K}^{*} ) d K} = p ( Y \vert {γ}_{b} , ξ , T , K , {K}^{*} ) p ( K \vert α , x ) \frac{1}{\int p ( K \vert α , x ) p ( Y \vert {γ}_{b} , ξ , T , K , {K}^{*} ) d K} ∝ p ( Y \vert {γ}_{b} , ξ , T , K , {K}^{*} ) p ( K \vert α , x )$$

since the expression

$$\frac{1}{\int p ( K \vert α , x ) p ( Y \vert {γ}_{b} , ξ , T , K , {K}^{*} ) d K}$$

is a coefficient independent from K.

By exchange with K and K*, the expression is easily deducted for p(K*|Y, γ_{b}, ξ, T, α, K, x, B)∝p(K*|Y, γ_{b}, ξ, T, K, α)∝p(Y|γ_{b},ξ,T,K,K*)p(K*|α), since variable x* is not a random variable.

Concerning parameter α: p(α|Y,γ_{b},ξ,T,K,x,B)=p(α|K,x), since α may be considered as a posteriori independent from Y, γ_{b}, ξ, T and B, since its dependence with relation to these parameters moves through K and x.

According to the Bayesian rule used on the second member of the previous equation:

$$p ( α \vert Y , {γ}_{b} , ξ , T , K , {K}^{*} , x , B ) = \frac{p ( K , {K}^{*} , α , x )}{\int p ( K , {K}^{*} , α , x ) d α} = \frac{p ( K \vert α , x ) p ( {K}^{*} \vert α ) p ( x ) p ( α )}{\int p ( K \vert α , x ) p ( {K}^{*} \vert α ) p ( x ) p ( α ) d α} = \frac{p ( K \vert α , x ) p ( {K}^{*} \vert α ) p ( x ) p ( α )}{p ( x ) \int p ( K \vert α , x ) p ( {K}^{*} \vert α ) p ( α ) d α} = p ( K \vert α , x ) p ( {K}^{*} \vert α ) p ( α ) \frac{1}{\int p ( K \vert α , x ) p ( {K}^{*} \vert α ) p ( α ) d α} ∝ p ( K \vert α , x ) p ( {K}^{*} \vert α ) p ( α ) ,$$

since the expression

$$\frac{1}{\int p ( K \vert α , x ) p ( {K}^{*} \vert α ) p ( α ) d α}$$

is a coefficient independent from α.

Concerning parameter x: p(x|Y,γ_{b},ξ,T,K,K*α,B)=p(x|K,α,B), since x may be considered as a posteriori independent from Y, γ_{b}, ξ, K* and T, since its dependence with relation to these parameters moves through K.

According to the Bayesian rule applied to the second member of the previous equation, and noting Pr(B) as the discrete values probability of parameter B:

$$p ( x \vert Y , {γ}_{b} , ξ , T , K , {K}^{*} , α , B ) = \frac{p ( K , α , x , B )}{\int p ( K , α , x , B ) d x} = \frac{p ( K \vert α , x , B ) p ( x \vert α , B ) p ( α )}{\int p ( K \vert α , x , B ) p ( x \vert α , B ) p ( α ) d x} = \frac{p ( K \vert α , x ) p ( x \vert B ) Pr ( B ) p ( α )}{Pr ( B ) p ( α ) \int p ( K \vert α , x ) p ( x \vert B ) d x} = p ( K \vert α , x ) p ( x \vert B ) \frac{1}{\int p ( K \vert α , x ) p ( x \vert B ) d x} ∝ p ( K \vert α , x ) p ( x \vert B )$$

since the expression

$$\frac{1}{\int p ( K \vert α , x ) p ( x \vert B ) d x}$$

is a coefficient independent from x.

Lastly, concerning parameter B: Pr(B|Y,γ_{b},ξ,T,K,K*,α,x)=Pr(B|x), since B may be considered as a posteriori independent from Y, γ_{b}, ξ, T, K, K* and α, since its dependence with relation to these parameters moves through x.

According to the Bayesian rule used on the second member of the previous equation:

$$Pr ( B \vert Y , {γ}_{b} , ξ , T , K , {K}^{*} , α , x ) = \frac{p ( x \vert B ) Pr ( B )}{p ( x )} ∝ p ( x \vert B ) Pr ( B )$$

since the expression

$$\frac{1}{p ( x )}$$

is a coefficient independent from B.

To recapitulate:

p(γ_{b}|Y,ξ,T,K,K*,α,x,B)=p(γ_{b}|Y,ξ,T,K,K*)∝p(Y|γ_{b},ξ,T,K,K*)p(γ_{b}), (3)

p(ξ|Y,γ_{b},T,K,K*,α,x,B)=p(ξ|Y,γ_{b},T,K,K*)∝p(Y|γ_{b},ξ,T,K,K*), (4)

p(T|Y,γ_{b},ξ,K,K*,αx,B)=p(T|,Y,γ_{b},ξ,K,K*)∝p(Y|γ_{b},ξ,T,K,K*)p(T), (5)

p(K|Y,γ_{b},ξ,T,α,K*,x,B)=p(K|Y,γ_{b},ξ,T,K*,α,x)∝p(Y|γ_{b},ξ,T,K,K*)p(K|α,x)′ (6)

p(K*|Y,γ_{b},ξ,T,K,α,B)=p(K*|Y,γ_{b},ξ,T,K,α)∝p(Y|γ_{b},ξ,T,K,K*)p(K*|α)′ (6*)

p(α|Y,γ_{b},ξ,T,K,K*,x,B)=p(α|K,K*,x)∝p(K|α,x)p(K*|α,x)p(α), (7)

p(x|Y,γ_{b},ξT,K,K*,α,B)=p(x|K,α,B)∝p(K|,α,x)p(x|B), and (8)

Pr(B|Y,γ_{b},ξ,T,K,K*,α,x)=Pr(B|x)∝p(x|B)Pr(B). (9)

Equation (6*) is only relevant in the aforementioned case 1) following estimation of the digestion matrix α.

It should be noted that when working with aforementioned cases, the constant parameter entries should be omitted (ξ for case 1 or α for cases 2 and 3) to ensure that they do not appear in the dependencies.

In cases 2) and 3), parameter K* is also known, as α is either known, as in case 2, or presumed equal to 1 in case 3. K* therefore does not come into play in the distributions. So in case 3), equation (6) is expressed as p(K′|Y, γ_{b}, ξ′, T, x, B)=p(K′|Y, γ_{b}, ξ′, T, x).

Note that in the particular case where parameter K is defined deterministically from x (either through perfect digestion and deterministic, or deterministic with a known), there is no longer any uncertainty regarding this parameter. This is reflected by the set of simplified equations below:

p(γ_{b}|Y,ξ,T,α,x,B)=p(γ_{b}|Y,ξ,T,x)∝p(Y|γ_{b},ξT,x)p(γ_{b}), (10)

p(ξ|Y,γ_{b},T,x,B)=p(ξ|Y,γ_{b},T,x)∝p(Y|γ_{b},ξ,T,x)p(ξ), (11)

p(T|Y,γ_{b},ξ,x,B)=p(T|Y,γ_{b},ξ,x)∝p(Y|γ_{b},ξ,T,x)p(T), (12)

p(x|Y,γ_{b}ξ,T,B)=p(x|Y,γ_{b},ξ,T)∝p(Y|γ_{b},ξT,K)p(x|B), and (13)

Pr(B|Y,γ_{b},ξ,T,x)=Pr(B|x)∝p(x|B)Pr(B). (14)

Equations (10) to (13) are in fact those developed in patent application EP 2 028 486, with the difference that one hierarchy stage is added (addition of the conditional prior distribution p(x|B).

It may be that there is no biological state parameter. In this case, B is determined beforehand, equation (9) is no longer relevant and equations (3) to (8) no longer contain variable B.

There may also be both a biological state parameter and a deterministic digestion.

Equations (3) to (9) show that the conditional posterior probabilities distributions of all parameters γ_{b}, ξ, T, K, K*, α, x and B can be expressed analytically as they are proportional to products of prior distributions or probabilities which can either be modeled or determined through learning.

We show in particular, as can easily be inferred from the EP 2 028 486 document, that likelihood function p(Y|γ_{b},ξ,T,K,K*) follows a normal distribution of average HK+H*K* and of inverse variance γ_{b}, where H and H* correspond to a rewriting of the equation (1) as Y=HK+H*K*+b(γ_{b}).

For noise γ_{b}, a prior probability model p(γ_{b}) is used of the Gamma distribution type with parameters α_{G} and β_{G}. In particular, when α_{G} tends to 0 and β_{G} to infinity, this Gamma distribution becomes a Jeffreys distribution (which reflects the absence of prior knowledge available on measurement noise).

For retention time T, a prior probability model p(T) is used of the uniform distribution type between a vector Tmin of minimal values for each peptide i and a vector Tmax of maximum values for each peptide i.

In all three cases of aforementioned embodiments, we proceed as follows:
1)—for gain ξ, with knowledge of its nominal value ξ₀, we use a Dirac distribution centered on ξ₀ to model its prior p(ξ) and posterior p(ξ|y, K, K*, T, γ_{b}) probability,
   for digestion coefficient α, we use a probability model of the uniform distribution type in an interval between 0 and 1,
   for concentration of peptides K, given ξ₀ and the relationship between K and x (and K* and x*) determined by digestion matrix αD, with possible Gaussian white noise, the conditional prior probability model p(K|α,x) is of the normal type with average distribution μ_{K|x} and inverse covariance matrix Γ_{K|x}=R_{K|x}⁻¹,
   same for p(K*|α);
2)—For gain we use a prior probability model p(ξ) of the normal type with average distribution and inverse covariance matrix Γ_{ξ}=Rξ⁻¹. In as much as the gain parameter ξ is in linear relation to observation Y, Y=Gξ+b(γ_{b}), we note that we can consider that likelihood function p(Y|γ_{b},ξ,T,K,K*)=p(Y|γ_{b},ξ,T,K) follows a normal distribution of average Gξ=HK+H*K* and of inverse variance γ_{b},
   for digestion coefficient α, assuming that the constant nominal value α₀ is known, we chose a Dirac distribution centered in α₀ to model its prior p(α) and its posterior p(α|Y,γ_{b},ξ,T,K,K*,x,B)=p(α|K,K*,x) probability,
   for the concentration of peptides K, given ξ and the relationship between K and x determined by digestion matrix α₀D, with possible white Gaussian noise, the conditional prior probability model p(K|α,x)=p(K|x) is of the normal type with average distribution μ_{K|x} and inverse covariance matrix Γ_{K|x}=R_{K|x}⁻¹;
3) If nominal values of the two parameters α et ξ are unknown, an overall gain ξ′ should be estimated. For this we use a Dirac distribution centered on 1 for α, as well as for the prior as for the posterior distributions,
   for overall gain ξ′, we use a prior probability model p(ξ′) of the normal type with average distribution μ_{ξ′} and inverse covariance matrix Γ_{ξ′}=R_{ξ′}⁻¹. In as much as the gain parameter ξ′ is in linear relation to observation Y, Y=Gξ′+b(γ_{b}), we note that we can consider that likelihood function p(Y|γ_{b}, ξ′, T, K′) follows a normal distribution of average Gξ′=HK′+H*K′* and of inverse variance γ_{b},
   for the potential concentration of peptides K′, given overall gain ξ′ and the relationship between K′ and x determined by digestion matrix D, with possible white Gaussian noise, the conditional prior probability model p(K′|α,x)=p(K′|x) is of the normal type with average distribution μ_{K′|x} and inverse covariance matrix Γ_{K′|x}=R_{K′|x}⁻¹.

For concentration of proteins of interest x, we use a conditional prior probability model p(x|B) of normal type with average distribution μ_{x|B} and inverse covariance matrix Γ_{x|B}=R_{x|B}⁻¹. Mean and inverse covariance matrices of concentration x for each of the possible B states are for instance determined by learning through sets of samples for which the corresponding state B is previously known.

For the state B, prior probability Pr(B) is with discrete values. If one considers two possible states, a healthy state S and a pathological state P, it is possible to a priori state a pair of values pₛ and pₚ between 0 and 1 and so that pₛ+pₚ=1.

In view of the prior probabilities detailed above and of equation (3), it follows that the posterior probability for noise γ_{b} is expressed in the form of a Gamma distribution multiplied by the likelihood function, which is in the form of a normal distribution. As the family of Gamma distributions is conjugated by the family of normal distributions, we find that this posterior probability p(γ_{b}|Y,ξ,T,K) itself follows a Gamma distribution for parameters α′_{G} and β′_{G} of the following values:

α′_{G}=α+N/2, and

$${β}_{G}^{′} = {( {β}_{G}^{- 1} + \frac{{‖ Y - {H}^{T} Y - {H}^{* T} {H}^{*} {K}^{*} ‖}^{2}}{2} )}^{- 1} ,$$

where N is the number of pixels in chromatospectrogram Y and α_{G} and β_{G} are the prior hyper parameters. The same is true for the aforementioned case 3) with parameters ξ′ and K′.

The sampling of inverse variance γ_{b} of noise b may also arise simply as part of a Gibbs iterative sampling process.

In view of the prior probabilities detailed above and of equation (4), it follows that the posterior probability for gain ξ in case 2 is expressed in the form of a normal distribution multiplied by the likelihood function, which is itself normal. As the family of normal distributions is self-conjugating, we find that this posterior probability p(ξ|Y,γ_{b},T,K) also follows a normal distribution with average μ′_{ξ} and inverse covariance matrix Γ′_{ξ} verifying the following equations:

μ′_{ξ}=Γ′_{ξ}⁻¹(Γ_{ξ}μ_{ξ}+γ_{b}G^{T}Y), and

Γ′_{ξ}=Γ_{ξ}+γ_{b}G^{T}G.

In order to avoid assuming a known gain value of the system, thus rendering its prior probability distribution uninformative, one may assume Γ_{ξ}=0, hence:

μ′_{ξ}=(G^{T}G)⁻¹G^{T}Y, and

Γ′_{ξ}=γ_{b}G^{T}G.

Sampling of gain ξ may thus arise simply as part of a Gibbs iterative sampling process.

The same is true in case 3) previously dealt with for the conditional posterior distribution for ξ′, making sure to use K′. In case 1), it follows that the posterior probability for ξ is expressed in the form of a Dirac distribution centered in ξ₀.

In view of the prior probabilities detailed above and of equation (5), it follows that the posterior probability for retention time T is expressed in the form of the product of a uniform distribution and the likelihood function. This posterior probability p(T|Y,γ_{b},ξ,K,K*), or p(T|Y, γ_{b}, ξ′, K′) in case n°3, cannot be expressed simply, so that the sampling for retention time T cannot be done simply as part of a Gibbs iterative sampling process. It will be necessary to use a sampling technique such as the Metropolis-Hastings algorithm.

In view of the prior probabilities detailed above and of equation (6), it follows that the posterior probability for the concentration of peptides K (or K′ in case number 3) is expressed in the form of a normal distribution multiplied by the likelihood function, which is itself normal. We then find through the conjugation of distributions that this posterior probability p(K|Y,γ_{b},ξ,T,α,x,K*) (or p(K′|Y, γ_{b}, ξ′, T, x) in case 3) also follows a normal distribution with average μ′_{K} and inverse covariance matrix Γ′_{K} (or even μ′_{K′} and Γ′_{K′} in case 3) verifying the following equations:

μ′_{K}=Γ′_{K}⁻¹(Γ_{K|x}μ_{K|x}+γ_{b}(H^{T}Y+H*^{T}H*K*)), and

Γ′_{K}=Γ_{K|x}+γ_{b}H^{T}H.

With case 3, K is replaced by K′ in the above equations.

The sampling of the concentration of peptides K (or peptides K′ in case 3) may thus arise simply as part of a Gibbs iterative sampling process.

The same is true for the concentration of peptides K* from the marker protein of concentration x*, which follows a reasoning analogous with the precedent in case 1).

In view of the prior probabilities detailed above, of equation (7) and of the aforementioned cases, it follows that posterior probability p(α|K,K*,x) for digestion coefficient a is expressed in the form of a Dirac distribution centered in α₀ in case 2), and in the form of a Dirac distribution centered on 1 for case 3). Therefore, sampling of this parameter in the example under review is trivial. In case 1), posterior distribution p(αK,K*,x) cannot be expressed simply, so that the sampling for digestion coefficient α cannot be done simply as part of a Gibbs iterative sampling process. It will be necessary to use a sampling technique such as the Metropolis-Hastings algorithm.

In view of the prior probabilities detailed above and of equation (8), it follows that the posterior probability p(x|K,α,B) (or even p(x|K′, B) in case 3) for the concentration of proteins of interest x is expressed, as with peptides, by means of a self-conjugation of the prior distribution with the likelihood function in the form of a normal distribution with average μ′ₓ and inverse covariance matrix Γ′ₓ, verifying the following equations:

μ′ₓ=Γ′ₓ⁻¹(Γ_{K|x}K^{T}D+Γ_{x|B}μ_{x|B}), and

Γ′ₓ=Γ_{x|B}+Γ_{K|x}D^{T}D.

The sampling of the concentration of proteins of interest x may thus arise simply as part of a Gibbs iterative sampling process.

In view of the prior probabilities detailed above and of equation (9), it follows that the posterior probability Pr(B|x) for biological state B is expressed as follows, assuming the two aforementioned states S and P:

$$\begin{matrix}Pr ( B \vert x ) = \frac{p ( x \vert B ) Pr ( B )}{p ( x )} \\ = \frac{Pr ( B ) \sqrt{det ( {Γ}_{x \vert B} )} exp ( - \frac{1}{2} {( x - {μ}_{x \vert B} )}^{T} {Γ}_{x \vert B} ( x - {μ}_{x \vert B} ) )}{\begin{matrix}{p}_{s} \sqrt{det ( {Γ}_{x \vert S} )} exp ( - \frac{1}{2} {( x - {μ}_{x \vert s} )}^{T} {Γ}_{x \vert s} ( x - {μ}_{x \vert s} ) ) + \\ {p}_{p} \sqrt{det ( {Γ}_{x \vert P} )} exp ( - \frac{1}{2} {( x - {μ}_{x \vert P} )}^{T} {Γ}_{x \vert P} ( x - {μ}_{x \vert P} ) )\end{matrix}}\end{matrix}$$

The sampling of biological state B may thus arise simply as part of a Gibbs iterative sampling process.

For parameters whose conditional posterior probability follows a normal distribution, i.e. parameters

1) α, K, K*, x

2) ξ, K, x

3) ξ′, K′, x

depending on the case under review, sampling as part of the Gibbs iterative sampling process follows an algorithm A.
ALGORITHM A (for a vector x of size n following a normal distribution of average μ and inverse covariance matrix Γ):
   Calculation of covariance matrix R=Γ⁻¹,
   Calculation of the Cholesky decomposition of covariance matrix R=Λ^{T}Λ,
   Generation of a vector v of n independent variables distributed according to a reduced centered normal distribution,
   Calculation of sampling x=μ+Λ^{T}v.

For parameter γ_{b} for which the conditional posterior probability follows a Gamma distribution, sampling as a part of the iterative Gibbs process follows an algorithm B.
ALGORITHM B (for a vector x of size N):
   Calculation of α′_{G}=α_{G}+N/2,
   Calculation of

$${β}_{G}^{′} = {( {β}_{G}^{- 1} + \frac{χ ( K , {K}^{*} , ξ , {γ}_{b} , T )}{2} )}^{- 1} ,$$

Generation of a random variable according to the Gamma distribution with parameters α′_{G} and β′_{G},
   where

$$χ ( K , {K}^{*} , ξ , {γ}_{b} , T ) = {‖ Y - {\sum }_{i = 1}^{I} {\sum }_{j = 1}^{J} {\sum }_{K = 1}^{K} {ξ}_{i} {π}_{ij} ( {K}_{i} {π}_{ijk}^{′} {s}_{ijk} + {K}_{i}^{*} {π}_{ijk}^{′ *} {s}_{ijk}^{*} ) {c}_{i}^{T} ( {T}_{i} ) ‖}^{2} .$$

Note: in case 3), is replaced by ξ′, K by K′ and K* by K′*.

For parameter T, for which the conditional posterior probability has no simple expression, sampling as a part of the iterative Gibbs process follows an algorithm C implementing the Metropolis-Hastings algorithm with random walk.
ALGORITHM C (for generating T in iteration k+1, noted T^{(k+1)}):
   Generate a vector of proposed values T^{P} according to normal distribution of average T^{(k)} and inverse covariance matrix Γ_{MHMA}, where Γ_{MHMA} steers the generation of random variables,
   Generate a value u according to uniform distribution on interval [0, 1],
   Calculate:

$$δ = exp ( - \frac{{γ}_{b}}{2} \cdot ( \begin{matrix}χ ( {K}^{( k )} , {K}^{* ( k )} , {ξ}^{( k + 1 )} , {γ}_{b}^{( k + 1 )} , {T}^{P} ) - \\ χ ( {K}^{( k )} , {K}^{* ( k )} , {ξ}^{( k + 1 )} , {γ}_{b}^{( k + 1 )} , {T}^{( k )} )\end{matrix} ) ) ,$$

If δ>u then T^{(k+1)}=T^{P}, or else T^{(k+1)}=T^{(k)}.

Note: in case 3), ξ is replaced by ξ′, K by K′ and K* by K′*.

For parameter B, sampling as part of the Gibbs iterative sampling process follows an algorithm D.
ALGORITHM D (for generating B in iteration k, noted B^{(k)} when B has two possible states, S and P):
   Generate a value u according to uniform distribution on interval [0, 1],
   If u ∈ [0,p_{S}] then B^{(k)}=S and p_{B}^{(k)}=[1,0], or else B^{(k)}=P and p_{B}^{(k)}=[0,1].

Finally, for parameter α, in case 1) for which the conditional posterior probability has no simple expression, sampling as a part of the iterative Gibbs process follows an algorithm E implementing the Metropolis-Hastings algorithm with random walk.
ALGORITHM E (for generating a in iteration k+1, noted α^{(k+1)}):
   Generate a vector of proposed values α^{P} according to normal distribution of average α^{(k)} and inverse covariance matrix Γ_{MHMA}, never leaving interval [0, 1], where Γ_{MHMA} steers the generation of random variables,
   Generate a value u according to uniform distribution on interval [0, 1],
   Calculate

$$δ = \frac{p ( K \vert {α}^{P} , x ) p ( {K}^{*} \vert {α}^{P} )}{p ( K \vert {α}^{( k )} , x ) p ( {K}^{*} \vert {α}^{( k )} )} ,$$

If δ>u then α^{(k+1)}=α^{P}, or else α^{(k+1)}=α^{(k)}.

In view of the preceding and in reference to FIG. 3, a method for estimating biological or chemical parameters, or more accurately, in the framework of the non limiting example selected, a method for estimating molecular concentrations of proteins of interest and for aiding diagnosis implemented by the processor 28 through execution of instructions 30 includes a principal phase 100 for jointly estimating the said uncertain parameters of a biological sample E the biological state of which is unknown, and including at least one of the following two parameters: Vector x of concentrations of proteins of interest and biological state B.

Executing this principal phase 100 of joint estimation assumes that a certain number of data and parameters are already known and saved in the database 32, to include:
the parameters indicated as certain and constant in the biological processing chain 12, i.e. those that are invariant from one biological treatment to another,
an established and identified selection of components of interest, namely in the framework of the non limiting example used, a selection of proteins of interests from which vector x of concentrations of proteins may be determined, and
parameters of prior probabilities models, conditional or not, of uncertain parameters from which may be determined conditional posterior probabilities models of each of these parameters.

When at least a part of these data is unknown, the method for estimating biological or chemical parameters and for aiding diagnosis may optionally be supplemented by one or several of the following preliminary phases:
a first calibration phase 200, called external calibration, of the processing chain 12, carried out with at least one sample E_{CALIB1} of external calibration components of which the concentration is known, such as a sample of standard proteins or predetermined proteins contained in protein cocktails, with the molecular concentration of these calibration proteins known:
   to determine certain and still unknown parameters then to save them in the database 32 and/or
   to determine stable parameters (such as average or variance) of prior probability models for uncertain parameters and to save them in the database 32,
(in cases 1 and 2, this external calibration 200 can be used to respectively determine a parameter of the probability distribution of a (such as average, covariance, minimum, maximum, etc.) or the average value of α)
a selection phase 300 of components of interest, such as proteins of interest in the framework of the non limiting example shown, carried out using a set E_{REF} of so-called reference samples, because their respective biological states are known, making it possible to select those proteins for which concentrations are more discriminating with relation to possible biological states as proteins of interest,
a second optional external calibration phase 400 of the processing chain 12, carried out with at least one sample E_{CALIB2} of components selected from among components of interest and for which the concentration is known, such as a sample of proteins of interest for which the molecular concentration is known:
   to carry out a more refined determination of certain parameters and their updates in the database 32, and/or
   to carry out a more refined determination of stable parameters (such as average or variance) of prior probability models of uncertain parameters and to update them in the database 32,
(in cases 1 and 2, this external calibration 400 can be used to respectively determine a parameter of the probability distribution of a (such as average, covariance, minimum, maximum, etc.) or the average value of α)
a learning phase 500 for at least a part of the prior probability models of uncertain parameters. This phase is carried out using the set of samples E_{REF} and at least one sample E* of marker components (in the example chosen, these are proteins) which are equivalent to the components of interest but have different masses, to determine parameters of these models and to save them in the database 32.

Phases 200 and 300 may be qualified as discovery phases as they are executed before any particular component of interest has been selected, while phases 400, 500 and 100 may be qualified as validation phases, since they are executed with the focus specifically on parameters of clearly identified components of interest.

When the five aforementioned phases are applied, they should be executed in the following order: (1) the first phase of external calibration 200 to determine certain parameters that are not yet known and stable statistical parameters using the sample E_{CALIB1}, and their subsequent saving in the database 32, followed by (2) the selection phase 300 to determine components of interest using the set of samples E_{REF}, as well as certain parameters and stable statistical parameters, and their subsequent saving in the database 32, followed by (3) the second optional phase of external calibration 400 to make a refined determination of certain parameters and stable statistical parameters using the sample E_{CALIB2}, which may contain marker components, and to update them in the database 32, followed by (4) the learning phase 500 to determine at least a part of the prior probability models of uncertain parameters using E* and E_{REF} samples, to determine certain parameters and to make an identified selection of components of interest, then save them in the database 32, followed by (5) the principal phase 100 of joint estimation to estimate biological or chemical parameters, i.e. the molecular concentrations of proteins of interest in the example chosen, and carry out a diagnosis aid using samples E, E* and data previously saved in the database 32.

It should be noted that phases 500 and 100 use sample E* of marker components, so that they may be considered as including an internal calibration for a quantitatively accurate estimate of biological or chemical parameters. It may also be the same for the second optional phase 400.

Phases 100 to 500 will now be detailed as part of the example chosen of a biological analysis of a biological sample, for which the biological parameters contain molecular concentrations of proteins of interest, but these phases can be applied more generally as indicated earlier.

The principal phase 100 of joint estimation includes a first measuring step 102 during which, as set out in FIG. 1, sample E to which E* marker proteins are added, traverses the entire processing chain 12 of the system 10 for performing a chromatospectrogram Y.

Next, during the initialization phase 104, random variables γ_{b}, ξ, T, K, α, x and B are all initialized by the processor 28 to an initial value γ_{b}⁽⁰⁾, ξ⁽⁰⁾, T⁽⁰⁾, K⁽⁰⁾, α⁽⁰⁾, x⁽⁰⁾ and B⁽⁰⁾.

The processor 28 then executes, by applying a Markov Chain Monte-Carlo algorithm and on an index k varying from 1 to kmax, a Gibbs sampling loop 106 for sampling all random variables initialized in light of their respective conditional posterior probabilities distributions such as analytically espressed. kmax is the maximal value taken by index k before a predetermined stop criterion is reached. The stop criterion may be for example a previously set maximal number of iterations, the fulfillment of a stability criterion (such as the fact that an additional iteration has no significant impact on the chosen estimator of random variables), or something else.

More precisely, where k varies from 1 to kmax, the loop 106 contains the following successive samplings:

In case 1):
Generate a sample γ_{b}^{(k)} from the posterior distribution p(γ_{b}|Y,ξ^{(k)},T^{(k-1)},K^{(k-1)},K*^{k-1)}) in accordance with algorithm B,
Generate a sample T^{(k)} from the posterior distribution p(T|Y,γ_{b}^{(k)},ξ^{(k)},K^{(k-1)},K*^{(k-1)}, in accordance with algorithm C,
Generate a sample K^{(k)} from the posterior distribution p(K|Y,γ_{b}^{(k)},ξ^{(k)},T^{(k)},K*^{(k-1)},α^{(k-1)},x^{(k-1)}) in accordance with algorithm A,
Generate a sample K*^{(k)} from the posterior distribution p(K*|Y,γ_{b}^{(k)},ξ^{(k)},T^{(k)},K^{(k)},α^{(k-1)},x^{(k-1)}) in accordance with algorithm A,
   and, due to the hierarchical structure of the model as illustrated by FIG. 2:
Generate a sample α^{(k)} from the posterior distribution p(α|K^{(k)},K*^{(k)},x^{(k-1)}) in accordance with algorithm E,
Generate a sample x^{(k)} from the posterior distribution p(x|K^{(k)},α^{(k)},B^{(k-1)}) in accordance with algorithm A,
Generate a sample B^{(k)} from the posterior distribution Pr(B|x^{(k)}) in accordance with algorithm D.

In case 2):
Generate a sample ξ^{(k)} from the posterior distribution p(ξ|Y,γ_{b}^{(k-1)},T^{(k-1)},K^{(k-1)}) in accordance with algorithm A,
Generate a sample γ_{b}^{(k)} from the posterior distribution p(γ_{b}|Y,ξ^{(k)},T^{(k-1)},K^{(k-1)}) in accordance with algorithm B,
Generate a sample T^{(k)} from the posterior distribution p(T|γ_{b}^{(k)},ξ^{(k)},K^{(k-1)}) in accordance with algorithm C,
Generate a sample K^{(k)} from the posterior distribution p(K|Y,γ_{b}^{(k)},ξ^{(k)},T^{(k)},x^{(k-1)}) in accordance with algorithm A,
   and, due to the hierarchical structure of the model as illustrated by FIG. 2:
Generate a sample x^{(k)} from the posterior distribution p(x|K^{(k)},B^{(k-1)}) in accordance with algorithm A,
Generate a sample B^{(k)} from the posterior distribution Pr(B|x^{(k)}) in accordance with algorithm D.

In case 3):
Generate a sample ξ′^{(k)} from the posterior distribution p(ξ′|Y,γ_{b}^{(k-1)},T^{(k-1)},K′^{(k-1)}) in accordance with algorithm A,
Generate a sample γ_{b}^{(k)} from the posterior distribution p(γ_{b}|Y,ξ′^{(k)},T^{(k-1)},K′^{(k-1)}) in accordance with algorithm B,
Generate a sample T^{(k)} from the posterior distribution p(T|Y,γ_{b}^{(k)},ξ′^{(k)},K′^{(k-1)}) in accordance with algorithm C,
Generate a sample K^{(k)} from the posterior distribution p(K′|Y,γ_{b}^{(k)},ξ′^{(k)},T^{(k)},x^{(k-1)}) in accordance with algorithm A,
   and, due to the hierarchical structure of the model as illustrated by FIG. 2:
Generate a sample x^{(k)} from the posterior distribution p(x|K′^{(k)}B^{(k-1)}) in accordance with algorithm A,
Generate a sample B^{(k)} from the posterior distribution Pr(B|x^{(k)}) in accordance with algorithm D,

The processor 28 then executes an estimating step 108 during which the maximum a posteriori estimator of discrete values variable B is calculated to obtain an estimate \hat{B}, and the conditional expectation a posteriori estimator of continuous values variables γ_{b}, ξ, T, K, K*, α, x, is calculated to obtain estimates \hat{γ}_{b},\hat{ξ},\hat{T},\hat{K},\hat{K}*,\hat{α},\hat{x} (according to the case considered) retaining only k samples such as B^{(k)}=\hat{B}. In practice, the maximum a posteriori estimator of random variable B is approached by the selection of the state that appears the greatest number of times between the kmin and kmax indices. Again, in practice, the expectation a posteriori estimator of a random variable is approached by the average of its samples taken between the kmin and kmax indices, using only such samples as B^{(k)}=\hat{B}, with kmin holding a predetermined “warm up time” value deemed necessary so that during the Gibbs sampling the random sampling distribution will converge toward the joint posterior distribution, which could also be called the target distribution. For example, for a loop with kmax=500 samples, a value of kmin=200 for warm up time (i.e. 40% of the total number of iterations) appears reasonable.

Lastly, during a final step 110, estimates \hat{γ}_{b},\hat{ξ},\hat{T},\hat{K},\hat{K}*,\hat{α},\hat{x} and \hat{B} are returned, possibly accompanied by an uncertainty factor. In particular, the estimate \hat{x} gives a group of values for concentrations of proteins of interest in sample E and estimate \hat{B} is a diagnostic aid. It should be noted that the diagnosis may subsequently be made at a later time by a practitioner on the basis of this estimate, but it is not part of the object of this invention. It should also be noted that only empirical probabilities should be given for each biological state B that can be expressed as

$$\frac{{n}_{B}}{k max - k min + 1}$$

where n_{B} is the number of times an event B was selected between kmin and kmax iterations.

Numerous methods for calculating uncertainty factors are known and may by applied. These are not detailed here, but they may be based on the histogram analysis of samples obtained in step 106.

The first external calibration phase 200 of the biological processing chain 12 contains a first measuring step 202 during which, as set out in FIG. 1, the external calibration protein sample E_{CALIB1} traverses the entire processing chain 12 of the system 10 for providing a chromatospectrogram Y_{CALIB1}.

Treatment applied by the processor 28 to the signal Y_{CALIB1} consists in determining values not yet known of parameters that are certain, i.e. parameters that in reality remain relatively constant from one biological processing to another. These certain parameters are then considered and modeled by constants in the biological processing chain 12. These are for example coefficients of the digestion matrix D, or coefficients of the digestion gains correction matrix α if prior knowledge of D exists, or the widths of chromatographic and spectrometric peaks and proportions of proteins of interest with extra neutrons or charges. This processing may also consist of determining stable parameters (such as average and variance) of prior probabilities models of uncertain parameters. These stable parameters are then also considered and modeled by constants.

In the sample of external calibration proteins, some of the uncertain parameters are known this time as the vector of protein concentrations, but as with the principal phase 100, determining this is done by applying a digital sampling in accordance with the Markov Chain Monte-Carlo process. This time, it is nonetheless done in the standard manner on certain unknown parameters and is illustrated by reference 204. Step 204 therefore reproduces a part of the determination steps 104, 106, and 108 of the principal phase 100.

Lastly, during the final step 206 of the first external calibration phase, certain and stable parameters determined in the previous step are saved into the database 32.

The selection phase 300 assumes that all certain and stable parameters are known. It contains a first measuring step 302 during which, as set out in FIG. 1, the samples E_{REF} all traverse the entire processing chain 12 of the system 10 for providing Y_{REF} chromatospectrograms. In cases where possible biological states are a healthy state S and a pathological state P, the set of samples E_{REF} contains a subset of samples known as healthy and a subset of samples known as pathological. The objective of the selection phase 300 is to select those proteins for which the concentrations are the most discriminatory with relation to the two biological states from amongst a set of candidate proteins. We must then pass through an estimating step for these concentrations, unless this phase can be dispensed with and proteins of interest accessed directly. However, in this case, it is not possible to carry out isotopic marking, with the result that the concentrations will be known only in a relative manner. For this reason, gain parameter and digestion coefficient a are not variables of interest in this phase, and the E* sample is not included in each sample of the set of samples E_{REF}. In this case, a value is attributed to arbitrarily.

As with the principal phase 100, the determination is made by a digital sampling in accordance with the Markov Chain Monte-Carlo process, knowing that, this time, the biological state B is not a random variable, but a constant known for each of the abovementioned subsets.

Thus for each sample of the set E_{REF}, during an initialization phase 304, random variables γ_{b}, T, K and x are each initialized by the processor 28 to a first value γ_{b}⁽⁰⁾, T⁽⁰⁾, K⁽⁰⁾ and x⁽⁰⁾. In this phase, x is the vector of the concentrations of candidate proteins. If a value for the digestion coefficient is known it may be used advantageously in this model.

The processor 28 then executes a Gibbs sampling loop 306 of each of the random variables initialized in light of their respective conditional posterior probabilities distributions. More precisely, where k varies from 1 to kmax, the loop 306 contains the following successive samplings:
Generate a sample γ_{b}^{(k)} from the posterior distribution p(γ_{b}|Y,T^{(k-1)},K^{(k-1)}) in accordance with algorithm B,
Generate a sample T^{(k)} from the posterior distribution p(T|Y,γ_{b}^{(k)},K^{(k-1)}) in accordance with algorithm C,
Generate a sample K^{(k)} from the posterior distribution p(K|Y,γ_{b}^{(k)},T^{(k)},α^{(k-1)},x^{(k-1)}) in accordance with algorithm A,
Generate a sample x^{(k)} from the posterior distribution p(x|K^{(k)}) in accordance with algorithm A,

The processor 28 then executes an estimating step 308 during which the expectation a posteriori estimator is calculated for variable x to obtain an estimate for \hat{x}. In practice, the expectation a posteriori estimator is approached by the average of samples between the kmin and kmax indices. Since steps 304 and 308 are executed for each healthy or pathological reference sample, in the end a set of values for \hat{x} is obtained for each S or P biological state. We observe that the succession of steps 304, 306, 308 partially reproduces the determination steps 104, 106, 108 of principal phase 100.

Assuming that p(x|B=S) and p(x|B=P) follow normal distributions N with respective means μ_{S}, μ_{P} and inverse covariance matrices Γ_{S}, Γ_{P}, we obtain a relative model of these distributions during step 310 by estimating in a manner which is known per se an approximation of vector or matrix values μ_{S}, μ_{P}, Γ_{S} and Γ_{P}, from the set of values for \hat{x}. In particular, for the p-th candidate protein, we obtain scalar values for means and standard deviations of μ^{p}_{S}, μ^{p}_{P}, σ^{p}_{S} and σ^{p}_{P} for the probabilities distributions that follow p(x_{P}|B=S) and p(x_{P}|B=P), where xₚ designates the concentration in p-th protein. These distributions are noted respectively N(t,μ_{S}^{p},σ_{S}^{p}) and N(t,μ_{P}^{p},σ_{P}^{p}) for the p-th protein.

On the basis of these distributions during a step 312 for each candidate protein assuming that the proteins are independent from each other, the processor 28 determines the value x^{p}₀ of concentration xₚ for which the type I error relative to biological state B is equal to the type II error. Noting φ_{S}^{p}(x)=∫_{-∞}^{X}N(t,μ_{S}^{p},σ_{S}^{p})dt=p(xₚ≦x|B=S) and φ_{P}^{p}(x)=∫_{-∞}^{X}N(t,μ_{P}^{p},σ_{P}^{p})dt=p(xₚ≦x|B=P), this brings us back to determining the x^{p}₀ value for xₚ for which φ_{S}^{p}(x₀^{p})=1−φ_{P}^{p}(x₀^{p}). A score Sₚ is then attributed to the p-th protein on the basis of the value for φ_{S}^{p}(x₀^{p}) or φ_{P}^{p}(x₀^{p}) according to whether the protein under consideration is over or under expressed in state P. In other terms, we retain from φ_{S}^{p}(x₀^{p}) or φ_{P}^{p}(x₀^{p}) the one having the highest x^{p}₀ level. Score Sₚ may then be expressed as follows:

Sₚ=2·Max(φ_{S}^{p}(x₀^{p}),φ_{P}^{p}(x₀^{p}))−1.

With functions φ_{S}^{p} and φ_{P}^{p} positive, increasing and of values between 0 (in −∞) and 1 (in +∞), Sₚ is a value in the set [0,1]. Since furthermore φ_{S}^{p}(x₀^{p})=1−φ_{P}^{p}(x₀^{p}), the more Sₚ is closer to 1, the more it means that φ_{S}^{p}(x₀^{p}) and φ_{P}^{p}(x₀^{P}) are different and that the p-th protein is discriminatory in terms of concentration relative to biological state B.

In the light of this, during a final step 314 of the selection phase 300, the processor 28 selects proteins of interest from among candidate proteins on the basis of previously calculated Sₚ scores. For example, the only proteins used are those whose score is greater than a predetermined threshold S, or only the P proteins with the highest scores (where P=3, 5 or other). During this step as well, selected and identified proteins of interest are saved in the database 32.

Steps 312 and 314 for selecting P proteins of interest were detailed on the basis of an assumption of independence of the candidate proteins. However these may be generalized in an overall selection approach of differentiating sub proteome in the case of protein dependence, in the following manner.

From a list of candidate proteins, the center of each cloud of points obtained at the outcome of step 308 is calculated (i.e. the z values for S or P). With V as the vector connecting the two centers, points of the multidimensional space are projected on the mono-dimensional sub space engendered by V, with the projection of a Gaussian remaining Gaussian. By using the preceding information, we can then calculate the differentiation score for a set of proteins. Through progressive elimination of a number of these, we end up with a selection of proteins of interest.

In the same way, persons skilled in the art will also know how to generalize the selection of proteins of interest to a biological or chemical state B with more than two values.

The second optional phase 400 of external calibration of the biological processing chain 12 is identical to the first phase 200 of external calibration, other than that the sample of external calibration proteins E_{CALIB1} used in phase 200 is replaced by at least one sample of external calibration proteins E_{CALIB2} in which the proteins are chosen from among the proteins of interest selected in phase 300. Marker samples may be used.

Steps 402, 404 and 406 of this second optional phase 400 of external calibration are identical to steps 202, 204 and 206, so they will not be described again. Coefficients like the a matrix of digestion yields can nevertheless be left untreated in the 200 steps, but calibrated in the 400 steps because of the use of a limited number of proteins and of a more accurate acquisition chain model.

Thus, certain and stable parameters for which the determination is refined by the execution of optional phase 400 are updated in the database 32.

The learning phase 500 assumes that all certain and stable parameters are known (pursuant to results of phase 200 and perhaps phase 400) and that the proteins of interest are selected and identified (following phase 300). It includes a first measuring step 502 during which, as per the organizational drawing in FIG. 1, E_{REF} samples all traverse the processing chain 12 of the system 10 for providing chromatospectrograms Y. Marker protein sample E* is integrated into each sample of the set of samples E_{REF} because in this learning phase it is necessary to estimate absolute concentrations of proteins of interest and therefore to know the ξ gain parameter. As earlier, in cases where possible biological states are a healthy state S and a pathological state P, the set of samples E_{REF} contains a subset of samples known as healthy and a subset of samples known as pathological.

As with the principal phase 100, the determination is made by a digital sampling in accordance with the Markov Chain Monte Carlo process, keeping in mind that this time biological state B is not a random variable, but rather a known constant for each of the aforementioned subsets.

Thus for each sample of the set E_{REF}, during an initialization phase 504, random variables ξ, γ_{b}, T, K, K*, α and x are each initialized by the processor 28 to a first value ξ⁽⁰⁾, γ_{b}⁽⁰⁾, T⁽⁰⁾, K⁽⁰⁾, K*⁽⁰⁾, α⁽⁰⁾ and x⁽⁰⁾. In this phase, x is the vector of the concentrations of proteins of interest.

The processor 28 then executes a Gibbs sampling loop 506 of each of the random variables initialized in light of their respective conditional posterior probabilities distributions. More precisely, where k varies from 1 to kmax, the loop 506 contains the following successive samplings:

In case 1):
Generate a sample γ_{b}^{(k)} from the posterior distribution p(γ_{b}|Y,ξ^{(k)},T^{(k-1)},K*^{(k-1)}) in accordance with algorithm B,
Generate a sample T^{(k)} from the posterior distribution p(T|Y,γ_{b}^{(k)},ξ^{(k)},K^{(k-1)},K*^{(k-1)}) in accordance with algorithm C,
Generate a sample K^{(k)} from the posterior distribution p(K|Y,γ_{b}^{(k)},ξ^{(k)},T^{(k)},K*^{(k-1)},α^{(k-1)},x^{(k-1)}) in accordance with algorithm A,
Generate a sample K*^{(k)} from the posterior distribution p(K*|Y,γ_{b}^{(k)},ξ^{(k)},T^{(k)},K^{(k)},α^{(k-1)},x^{(k-1)}) in accordance with algorithm A,
Generate a sample α^{(k)} from the posterior distribution p(α|K^{(k)},K*^{(k)},x^{(k-1)}) in accordance with algorithm E,
Generate a sample x^{(k)} from the posterior distribution p(x|K^{(k)},α^{(k)}) in accordance with algorithm A,

In case 2):
Generate a sample ξ^{(k)} from the posterior distribution p(ξ|Y,γ_{b}^{(k-1)},T^{(k-1)},K^{(k-1)}) in accordance with algorithm A,
Generate a sample γ_{b}^{(k)} from the posterior distribution p(γ_{b}|Y,ξ^{(k)},T^{(k-1)},K^{(k-1)}) in accordance with algorithm B,
Generate a sample T^{(k)} from the posterior distribution p(T|Y,γ_{b}^{(k)},ξ^{(k)},K^{(k-1)}) in accordance with algorithm C,
Generate a sample K^{(k)} from the posterior distribution p(K|Y,γ_{b}^{(k)},ξ^{(k)},T^{(k)},x^{(k-1)}) in accordance with algorithm A,
Generate a sample x^{(k)} from the posterior distribution p(x|K^{(k)}) in accordance with algorithm A,

In case 3):
Generate a sample ξ′^{(k)} from the posterior distribution p(ξ′|Y,γ_{b}^{(k-1)},T^{(k-1)},K′^{(k-1)}) in accordance with algorithm A,
Generate a sample γ_{b}^{(k)} from the posterior distribution p(γ_{b}|Y,ξ′^{(k)},T^{(k-1)},K′^{(k-1)}) in accordance with algorithm B,
Generate a sample T^{(k)} from the posterior distribution p(T|Y,γ_{b}^{(k)},ξ′^{(k)},K′^{(k-1)}) in accordance with algorithm C,
Generate a sample K^{(k)} from the posterior distribution p(K′|Y,γ_{b}^{(k)},ξ′^{(k)},T^{(k)},x^{(k-1)}) in accordance with algorithm A,
Generate a sample x^{(k)} from the posterior distribution p(x|K′^{(k)}) in accordance with algorithm A,

The processor 28 then executes an estimating step 508 during which the expectation a posteriori estimator is calculated for variable x to obtain an estimate \hat{x}. In practice, the expectation a posteriori estimator is approached by the average of samples between the kmin and kmax indices. Since steps 504 and 508 are executed for each healthy or pathological reference sample, in the end a set of values for \hat{x} is obtained for each S or P biological state. We observe that the succession of steps 504, 506, 508 partially reproduces the determination steps 104, 106, 108 of principal phase 100.

Assuming again that p(x|B=S) and p(x|B=P) follow normal distributions N with respective averages μ_{S}, μ_{P} and inverse covariance matrices Γ_{S}, Γ_{P}, we obtain an absolute model of these distributions during step 510 by estimating in a manner which is known per se an approximation of vector and matrix values μ_{S}, μ_{P}, Γ_{S} and Γ_{P}, from the set of values for \hat{x}. Also during this step, the aforementioned parameters μ_{S}, μ_{P}, Γ_{S} et Γ_{P} are saved in the database 32.

During steps 508 and 510, it is also possible, if it is not yet known, to estimate the parameters of the prior probabilities distributions of gain ξ, of noise γ_{b}, or of retention time T in the same manner, but this time independent of biological state B.

It appears clearly that the type of method described above, implemented by means of the estimating system 10, can be used through fine hierarchal modeling of the processing chain 12 to provide reliable estimates of biological or chemical parameters, such as concentrations, of predetermined components of interest, and could even perhaps constitute a diagnostic aid when the learning phase 500 as described above can be carried out. In particular, this method excels in correctly evaluating peaks in measurements with a high level of noise or when said peaks are superimposed onto other peaks in a chromatospectrogram, which standard peak or spectrum analysis methods do less well.

Specific applications of this method include the detection of cancerous markers (in this case components of interest are proteins) in a biological sample of blood or urine.

It should also be noted that the invention is not limited to the embodiment described above. It will occur to persons skilled in the art that diverse modifications may be brought to the embodiment described above, in the light of the information that has been revealed here.

Notably, biological state B may take on more than two discrete values for detecting a pathology from among several possible ones, or for maintaining the possibility of diagnosing an uncertain biological state.

Moreover, components of interest are not necessarily proteins, but rather may more generally be molecules or molecular self-assemblies for biological or chemical analysis.

More generally, in the claims listed below, the terms used should not be interpreted as limiting the claims to the embodiments set out in this description, but rather should be interpreted to include all the equivalent situations that the claims intend to cover through their wording, the projection of which is within the reach of persons skilled in the art who apply their general knowledge to implementing the information here revealed.

1. A method for estimating biological or chemical parameters (x, B) in a sample (E) comprising the following steps:
put (102) the sample (E) through a processing chain (12),
obtain a representative signal (Y) of said biological or chemical parameters (x, B) as a function of at least one variable of the processing chain, and
estimate (104, 106, 108, 110) said biological or chemical parameters (x, B) using a signal processing device (14) by Bayesian inference, on the basis of a direct analytical modeling of said signal (Y) as a function of said biological or chemical parameters (x, B) and as a function of technical parameters (γ_{b}, ξ, T, K, K*, α) of the processing chain (12),
characterized in that at least two of said biological or chemical (x, B) or technical (γ_{b}, ξ, T, K, K*, α) parameters as a function of which direct analytical modeling of said signal (Y) is defined have a probabilistic dependence relationship between each other, and wherein said signal processing by Bayesian inference is furthermore accomplished on the basis of modeling by a conditional prior probability distribution of this dependence.

2. A method for estimating biological or chemical parameters (x, B) according to claim 1, wherein the estimating step (104, 106, 108, 110) of said biological or chemical parameters (x, B) includes, by approximation of the posterior joint probability distribution of said biological or chemical (x, B) and technical (γb, ξ, T, K, K*, α) parameters, conditionally to the obtained signal (Y), using a stochastic sampling algorithm:
a sampling loop (106) of at least part of said biological or chemical parameters of the sample (E) and of at least part (γ_{b}, ξ, T, K, K*, α) of said technical parameters of the processing chain, providing sampled values of these parameters, and
an estimate (108) of said at least part of said biological or chemical and technical parameters (x, B, γ_{b}, ξ, T, K, K*, α) calculated from said provided sampled values.

3. A method for estimating biological or chemical parameters (x, B) according to claim 2, wherein the estimate (108) of said at least part of said biological or chemical and technical parameters (x, B, γb, ξ, T, K, α) calculated from said provided sampled values comprises:
a calculation of the expectation or median or maximum a posteriori estimator for each continuous values parameter (x, γ_{b}, ξ, T, K, K*, α),
a calculation of the maximum a posteriori estimator for each discrete values parameter (B), or
a probability calculation of at least part of said biological or chemical and technical parameters (x, B, γ_{b}, ξ, T, K, K*, α).

4. A method for estimating biological or chemical parameters (x, B) according to any one of claims 1 to 3, wherein the biological or chemical parameters include a vector representative of concentrations of sample components, said method further including a preliminary calibration phase (200), called external calibration, comprising the following steps:
put (202) a sample (E_{CALIB1}) of external calibration components through the processing chain (12), with these external calibration components chosen from among the components of said sample and whose concentrations are known,
by this means obtain a signal representative of concentrations of external calibration components as a function of at least one variable of the processing chain (12) and of at least one constant parameter of unknown value and/or of at least one stable statistic parameter of the processing chain,
apply (204) at least part of said estimating step of said biological or chemical parameters using the signal processing device (14) by Bayesian inference, to infer the value of each constant parameter of unknown value and/or of each stable statistic parameter of the processing chain (12),
save (206) each constant parameter value and/or each stable statistic parameter value previously inferred in a memory (32).

5. A method for estimating biological or chemical parameters (x, B) according to any of claims 1 to 4, wherein said biological or chemical parameters (x, B) are relative to proteins and the sample (E) includes one of the elements of the group consisting of blood, plasma and urine.

6. A method for estimating biological or chemical parameters (x, B) according to any one of claims 1 to 5, wherein:
the signal (Y) representative of said biological or chemical parameters (x, B) is expressed as a function of molecular species concentrations (K),
these species (K) come from a decomposition of molecular species of interest (x),
the method includes an estimate of the number of said species obtained resulting from said decomposition of molecular species of interest (x).

7. A method for estimating biological or chemical parameters (x, B) according to claim 6, wherein:
the species contain peptides or polypeptides,
the molecular species of interest contain proteins that each have a number of these peptides or polypeptides,
a digestion yield (α) of proteins is defined in the form of a coefficients αᵢₚ matrix, where αᵢₚ designates the digestion yield of the p-th protein with relation to the i-th peptide or polypeptide, such that the molecular concentrations (K) of peptides or polypeptides are linked to a vector (x) representative of protein concentrations via a digestion matrix (D) and said digestion yield (α),
the method includes an estimate of this digestion yield (α).

8. A method for estimating biological or chemical parameters (x, B) according to claim 6, wherein:
the species contain peptides or polypeptides,
the molecular species of interest contain proteins that each have a number of these peptides or polypeptides,
an overall gain (ξ) of the processing chain (12) is defined so as to model said signal (Y) representative of biological or chemical parameters (x, B) by the relationship Y=ξ K, where K is a vector representative of concentrations of peptides or polypeptides,
the method includes an estimate of this overall gain (ξ).

9. A method for aiding diagnosis comprising the steps of a method for estimating biological or chemical parameters (x, B) according to any one of claims 1 to 8, wherein the biological or chemical parameters (x, B) of the sample (E) contain a biological or chemical state parameter (B) with discrete values, with each possible discrete value of that parameter associated with a possible state of the sample (E), and a vector representative of concentrations (x) of components of the sample (E), and wherein since the vector representative of concentrations (x) and the biological or chemical state parameter (B) have a probabilistic dependence among each other, the signal processing by Bayesian inference is furthermore carried out on the basis of modeling by prior probability distribution of the vector representative of concentrations (x) conditionally to possible values of the biological or chemical state parameter (B).

10. A method for aiding diagnosis according to claim 9, including a preliminary learning phase (500) comprising the following steps:
successively put (502) a plurality of reference samples (E_{REF}) through the processing chain (12), with the value of the biological or chemical state parameter (B) known for each reference sample,
obtain a representative signal of concentrations (x) of the components for each reference sample (E_{REF}) depending on at least one variable of the processing chain (12),
apply (504, 506, 508) at least part of the biological or chemical parameters estimating step using the signal processing device by Bayesian inference to determine values of component concentrations for each reference sample (E_{REF}),
determine (510) parameters of prior probability distribution for the vector representative of concentrations (x) conditionally to possible values of the biological or chemical state parameter (B), and
save (510) these probability distribution parameters in a memory (32)

11. A method for aiding diagnosis according to claim 9 or 10, including a preliminary phase (300) for selecting said components from a pool of candidate components, said preliminary selection phase (300) including the following steps:
successively put (302) a plurality of reference samples (E_{REF}) through the processing chain (12), with the value of the biological or chemical state parameter (B) known for each reference sample,
obtain a signal representative of concentrations (x) of the candidate components for each reference sample (E_{REF}) as a function of at least one variable of the processing chain (12),
apply (304, 306, 308) at least part of the biological or chemical parameters estimating step using the signal processing device by Bayesian inference to determine values representative of concentrations (x) of candidate components for each reference sample (E_{REF}),
determine (310) parameters of distribution of the vector representative of concentrations (x) of candidate components for each discrete value of the biological or chemical state parameter (B),
select (312, 314) from among the candidate components those for which the distributions are the most dissimilar from each other as a function of the biological or chemical state parameter values (B).

12. An estimating device (10) for biological or chemical parameters (x, B) in a sample (E) comprising:
a processing chain (12) of the sample (E) designed for providing a signal (Y) representative of said biological or chemical parameters (x, B) as a function of at least one variable of the processing chain,
a signal processing device (14) designed to apply, in combination with the processing chain (12), a method (100) for estimating biological or chemical parameters (x, B) or for aiding diagnosis according to any one of claims 1 to 11.

13. An estimating device (10) for biological or chemical parameters (x, B) according to claim 12, wherein the processing chain (12) includes a chromatography column (22) and/or a mass spectrometer (26) and is designed to provide a signal (Y) representative of concentrations (x) of components of the sample (E) as a function of a retention time (T) in the chromatography column (22) and/or a mass-to-charge ratio in the mass spectrometer (26).
